(19) United States
(12) Patent Application Publication
(10) Pub. No.: US 2002/0181866 A1
(43) Pub. Date: Dec. 5, 2002

(54) Low cost adhesive bonding of getter

(76) Inventors: Russell A. Crook, Hellertown, PA (US); Gajawalli V. Srinivasan, Allentown, PA (US); Kim E. Womer, Beaver Dams, NY (US)

Correspondence Address: CORNING INCORPORATED, SP-TI-3-1, CORNING, NY, 14831

(21) Appl. No.: 09/842,292

(22) Filed: Apr. 25, 2001

(51) Int. Cl. G02B 6/34; B65H 18/28; B65H 51/015; B65H 55/00; B32B 31/00

(52) U.S. Cl. 385/37; 156/292; 242/173

(57) ABSTRACT

A method for attaching a getter to a surface includes applying an adhesive to the surface and applying the getter to the adhesive layer so as to bond the getter to the surface.

### BACKGROUND OF INVENTION

1. Field of the Invention

In general, the invention relates to a hermetic package for fiber Bragg grating (FBG). More specifically, the invention relates to a method for attaching a getter to the inside of a package. Getters are a class of highly porous inorganic minerals that possess very high surface area. Getters are used for purifying air or liquids, for removing moisture, and for catalyzing chemical reactions.

2. Background Art

FBG is made by exposing the core of a single-mode optical fiber to a periodic pattern of intense ultraviolet light. The exposure produces a permanent change in the refractive index of the fiber's core. A small amount of light is reflected at each periodic refraction change. All the reflected light signals combine coherently to one large reflection at a particular wavelength when the grating period is equal to one half the input light's wavelength. The wavelength at which this large reflection occurs is called the Bragg wavelength. The Bragg wavelength depends on the temperature and strain of the grating region. However, for some applications, e.g., wavelength measuring systems for sensor and telecommunication systems, it is desirable that the Bragg wavelength remains constant or changes predictably.

Various methods have been devised for reducing the influence of temperature variations on Bragg wavelength. U.S. Pat. No. 6,044,189 issued to Miller discloses a temperature compensating structure for a FBG contained in optical fiber which comprises two plates made of materials having different temperature coefficients of expansion and bonded together. The optical fiber is bonded to the exposed surface of the plate having the lower temperature coefficient. The structure bends with changes in temperature and produces an elongation of the fiber with decreasing temperature. U.S. Pat. No. 5,042,898 issued to Morey et al. discloses a temperature control method which involves clamping the section of the optical fiber containing the FBG between two compensating members having different coefficients of thermal expansion. The compensating members apply longitudinal strains on the fiber in proportion to temperature changes such that the wavelength changes of the FBG that are attributable to strains compensate substantially for those attributable to temperature changes.

Another method for reducing the influence of temperature variations on the Bragg wavelength involves attaching a substrate having a negative coefficient of expansion to the FBG. FIG. 1 shows a negative expansion substrate 2 attached to a FBG 4 in an optical fiber 6. The FBG 4 is arranged in a metal case 8. Typically, the metal case 8 is made of a low-expansion alloy, e.g., iron-nickel-cobalt alloy sold under the trade name Kovar by Electronic Space Products International, Oregon. In this example, the negative expansion substrate 8 is beta-eucryptite. This material does not function properly when exposed to moisture. For this reason, the metal case 8 is usually hermetically sealed. FIGS. 2A and 2B show a lid 10 seam-sealed to the metal case 8 in a dry helium/nitrogen environment to form a FBG package 12.

FIG. 3 shows the inner surface 14 of the lid 10 (previously shown in FIGS. 2A and 2B). Two porous metal boxes 16, 18 are welded to the inner surface 14 of the lid 10. Each of the porous metal boxes 16, 18 contains a getter, e.g., ZSM-5 zeolite. The purpose of the getter is to absorb moisture should the seal formed between the lid 10 and the metal case 8 (see FIGS. 2A and 2B) become somehow compromised. Getters may also be provided to absorb other fluids that may enter the FBG package 12 (shown in FIGS. 2A and 2B) or evolve after the lid 10 has been seam-sealed to the metal case 8 (see FIG. 2B). The reason for encasing the getters in the porous metal boxes 16, 18 is to prevent large chunks of the getters which may break up during handling of the FBG package 12 (shown in FIGS. 2A and 2B) from falling on and possibly damaging the FBG 4 (shown in FIG. 1). However, the process of attaching the porous metal boxes 16, 18 to the lid 10 is very expensive. It is estimated that the cost of this operation is roughly one-quarter of the total cost of the FBG package 12.

### SUMMARY OF INVENTION

In one aspect, the invention relates to a method for attaching a getter to a surface. The method comprises applying an adhesive to the surface and applying the getter to the adhesive layer so as to bond the getter to the surface. In one embodiment, the adhesive comprises one selected from a group consisting of epoxies, polyimides, acrylates, silicone rubbers, thermosets, and thermoplastic materials. In another embodiment, the getter comprises one selected from a group consisting of ZSM-5 zeolite, Zirconium-Aluminum, Zirconium-Vanadium-Titanium-Iron, and Zirconium-Vanadium-Iron.

Other aspects and advantages of the invention will be apparent from the following description and the appended claims.

### BRIEF DESCRIPTION OF DRAWINGS

FIG. 1 shows a metal case containing a FBG.

FIGS. 2A and 2B show a lid seam-sealed to the metal case shown in FIG. 1.

FIG. 3 shows getters welded to the inner surface of the lid shown in FIGS. 2A and 2B.

FIG. 4 shows a getter bonded to a surface in accordance with one embodiment of the invention.

FIG. 5 shows a getter attached inside a FBG package in accordance with one embodiment of the invention.

FIG. 6 shows a test sample for evaluating effectiveness of bonded getters.

FIG. 7 shows a lap shear geometry for evaluating durability of bonded getters.

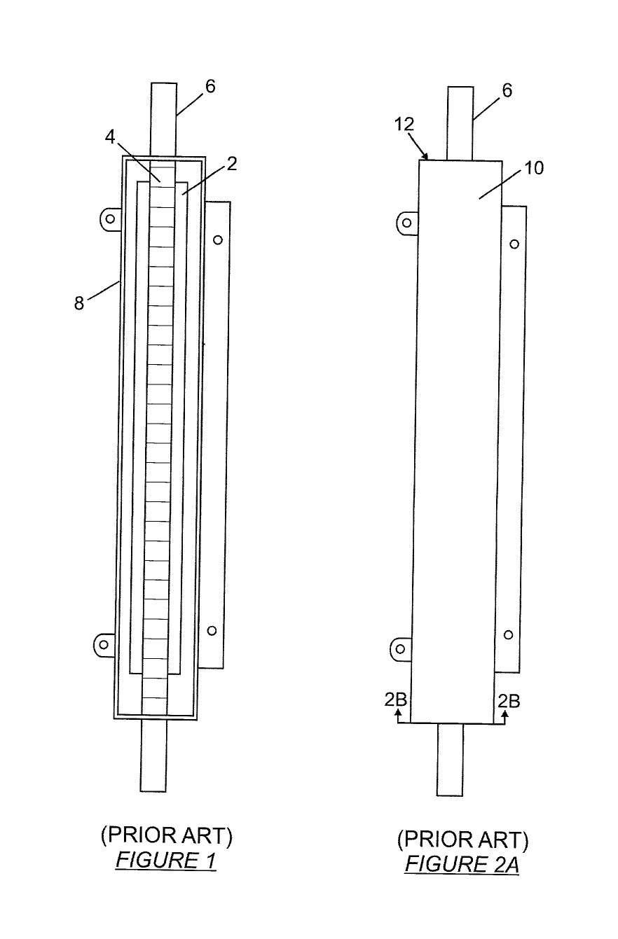

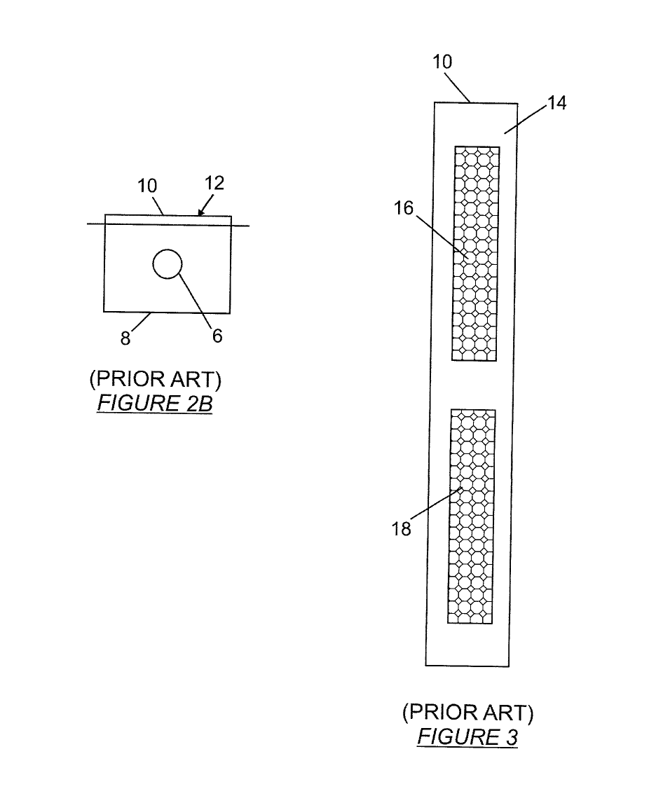

### DETAILED DESCRIPTION

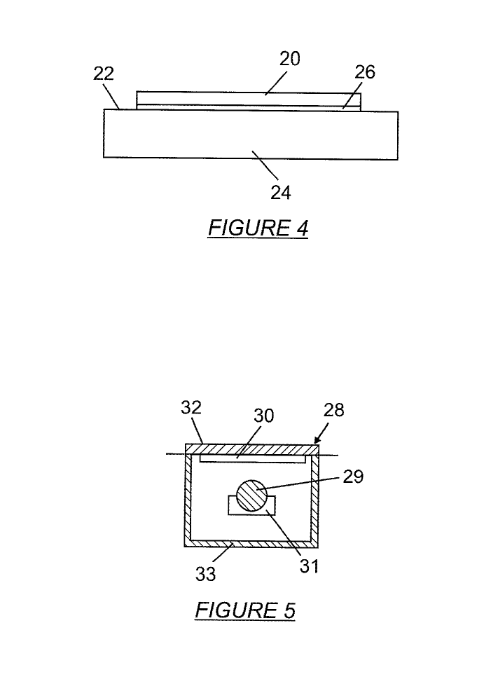

Embodiments of the invention provide a method for attaching a getter to a surface. In general, the method involves directly bonding the getter to the surface using an adhesive. FIG. 4 shows a getter 20 bonded to a surface 22 of a substrate 24 by an adhesive layer 26. Examples of getters that can be adhesively bonded include, but are not limited to, ZSM-5 zeolite, zirconium-aluminum, zirconium-iron, zirconium-vanadium-titanium-iron, and zirconium-vanadium-iron. Examples of adhesives that can be used to bond the getter 20 to the surface 22 include, but are not limited to, epoxies, polyimides, acrylates, silicon rubbers, and thermosets or thermoplastic materials. Because the getter 20 is bonded to the surface 22, the risk of large chunks of the getter 20 falling off is negligibly small. The bonded getter 20 can be used to purify air or liquids, remove moisture, or facilitate chemical reactions.

FIG. 5 shows a FBG package 28 incorporating bonded getters 30 (only one bonded getter is shown). The FBG package 28 comprises a container 33. The container 33 is made of a material having low coefficient of thermal expansion, e.g., Kovar™ iron-nickel-cobalt alloy, available from Electronic Space Products International, Oregon. In one embodiment, the alloy is plated with gold. A FBG 29 and a negative expansion substrate 31, e.g., beta-eucryptite, are arranged in the container 33. One or more getters 30 are bonded to the lid 32 using an adhesive. The lid 32 is seam-sealed to the container 33 in a dry helium/nitrogen environment. In one embodiment, the getters 30 are used to remove moisture from the FBG package 28 should the seal between the lid 32 and the container 33 become compromised. One example of a getter suitable for removing moisture is ZSM-5 zeolite. Other getters may be provided to remove gases such as hydrocarbons that may enter or evolve after the lid 32 is sealed to the container 33.

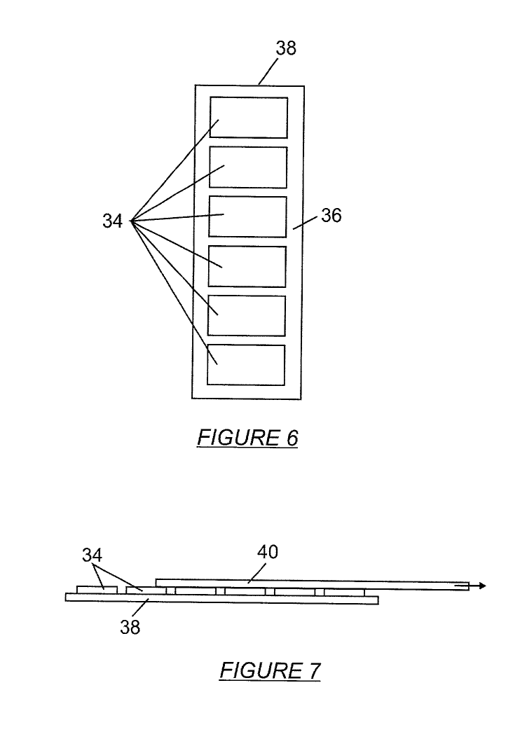

The following describes tests conducted to determine the effectiveness and durability of bonded getters in the presence of moisture. The test samples used in the study are prepared by applying an adhesive layer on a surface of a substrate and then applying getters on the adhesive layer. The getters are usually in the form of tablets. In the study, each test sample includes six getters 34 bonded to the surface 36 of a substrate 38, as shown in FIG. 6. The substrate is made of gold-plated Kovar™ alloy. Two types of getters were tested, including ZSM-5 zeolite, available from Exxon Mobil Corp., Dallas, Tex., and Vycor® porous glass, available from Corning Incorporated, Coming, N.Y. Examples of adhesives used in bonding the getter include Duralco epoxy resin, available from Cotronics Corporation, Brooklyn, N.Y.; EA9320 an epoxy adhesive made by Hysol; and MCA148 an internally formulated epoxy adhesive.

In some test samples, the substrate and/or the getter are surface treated using a binary mixture of γ-glycidoxypropyltrimethoxy silane and Bis[3-triethoxysilyl)propyl]tetrasulfide and then air dried. The bonded getter is activated by heating to 170° C. for 45 minutes. The bonded getter and substrate are then exposed to elevated humidity. The test samples are weighed before and after exposure to moisture. Table 1 gives a summary of the samples tested.

TABLE 1
Test Matrix For Evaluating Effectiveness and Durability
of Bonded Getter

| | | Silane-Treat | Silane-Treat | |
|---|---|---|---|---|
| Sample | Adhesive | Substrate | Getter | Getter |
| 1 | Duralco | Yes | Yes | ZSM5 |
| 2 | Duralco | Yes | Yes | ZSM5 |
| 3 | EA9360 | Yes | No | ZSM5 |
| 4 | MCA148 | Yes | Yes | ZSM5 |
| 5 | EA9360 | No | Yes | ZSM5 |
| 6 | Duralco | No | No | ZSM5 |
| 7 | EA9360 | Yes | No | Vycor |
| 8 | Duralco | Yes | Yes | Vycor |
| 9 | Duralco | Yes | Yes | Vycor |
| 10 | EA9360 | Yes | No | Vycor |
| 11 | MCA148 | Yes | Yes | Vycor |
| 12 | EA9360 | No | Yes | Vycor |
| 13 | Duralco | No | No | Vycor |
| 14 | EA9360 | Yes | No | Vycor |

The control specimen in the tests is the total weight gain of two ZSM-5 getters secured to a substrate by two welded porous metal boxes. These two porous metal boxes occupy roughly the same area on the substrate as the six bonded getters shown in FIG. 6. Table 2 shows the net change in the weight of the test samples after 2 hours and 4 hours, respectively, at 50% relative humidity. Also shown in Table 2 is the net change in the control specimen. Considering all the test samples, the maximum weight gain observed after 2 hours of exposure to moisture is 0.0224 g (or 0.0037 g per getter). The maximum weight gain for the getters secured to a substrate by welded boxes is 0.0052 g (or 0.0026 g per getter). Table 2 shows that the net change in weight at 4 hours is very small compared to weight gain at 2 hours for nearly all of the test samples, indicating that the getter is nearly saturated.

TABLE 2
Summary of Net Change in Weight of Test Samples After Exposure to
Moisture

| | Weight (g) | Weight | Weight (g) | Weight |
|---|---|---|---|---|
| | after 2 hours at | gain (g) | after 4 hours at | gain (g) |
| | 25° C. and 50% | after | 25° C. and 50% | after |
| Sample | RH | 2 hours | RH | 4 hours |
| 1 | 1.3429 | 0.0169 | 1.3431 | 0.0002 |
| 2 | 1.7723 | 0.0224 | 1.7747 | 0.0024 |
| 3 | 1.3833 | 0.0165 | 1.3842 | 0.0009 |
| 4 | 1.6568 | 0.0224 | 1.6587 | 0.0019 |
| 5 | 1.3475 | 0.0156 | 1.3481 | 0.0006 |
| 6 | 1.6520 | 0.0116 | 1.6555 | 0.0035 |
| 7 | 1.4398 | 0.0130 | 1.4417 | 0.0019 |
| 8 | 1.6909 | 0.0112 | 1.6943 | 0.0034 |
| 9 | 1.3542 | 0.0162 | 1.3553 | 0.0011 |
| 10 | 1.6310 | 0.0122 | 1.6349 | 0.0039 |
| 11 | 1.4260 | 0.0167 | 1.4271 | 0.0011 |
| 12 | 1.7204 | 0.0114 | 1.7245 | 0.0041 |
| 13 | 1.3290 | 0.0177 | 1.3300 | 0.0010 |
| 14 | 1.6570 | 0.0112 | 1.6610 | 0.004 |
| Control | 1.9230 | 0.0052 | 1.9233 | 0.0003 |
| Control | 1.9010 | 0.0050 | 1.9014 | 0.0004 |

For durability tests, the getters 34 are bonded to the substrates 38 and 40 using the lap shear geometry shown in FIG. 7. A shear force of up to 1000 G is then applied to the bonded getters 34 by pulling on the substrate 40 so that the substrate 40 moves relative to the substrate 38. Table 3 shows a summary of the lap shear strength of bonded saturated getter. The data shows that all of the adhesively bonded methods, with the possible exception of sample 11, have sufficient lap shear strength to withstand mechanical shock load up to 1000 G. This shows that the risk of chunks of the getter falling off is negligibly small. Silane does not appear to enhance the durability of the getter bond because there were no interfacial failures observed at the getter interface.

TABLE 3
Summary of Lap Shear Strength of Bonded Getters in Table 2

| | Maximum | Strength | |
|---|---|---|---|
| Sample | Load (kg) | (MPa) | Failure Mode |
| 1 | 11.73 | 0.151833 | Cohesive in Getter |
| 2 | 18.78 | 0.21941 | Adhesive in Substrate Surface (1) |
| 3 | 2.481 | 0.029517 | Cohesive in Getter |
| 4 | 7.72 | 0.064451 | Adhesive in Substrate Surface (1) |
| 5 | 11.05 | 0.132266 | Adhesive in Substrate Surface (2) |
| 6 | 15.07 | 0.132074 | Adhesive in Substrate Surface (1) |
| 7 | 9.32 | 0.115504 | Cohesive in Getter |
| 8 | 7.035 | 0.064561 | Cohesive in Getter |
| 9 | 3.824 | 0.05239 | Cohesive in Getter |
| 10 | 1.247 | 0.009064 | Adhesive in Substrate Surface (1) |
| 11 | --- | --- | Broke During Humidity Treatment |
| 12 | 4.057 | 0.036596 | Adhesive in Substrate Surface (1) |
| 13 | 2.004 | 0.015668 | Adhesive in Substrate Surface (1) |
| 14 | 2.453 | 0.025176 | Adhesive in Substrate Surface (1) |

(1) Adhesive failure is to the surface of the substrate 38 (shown in FIG. 6).
(2) Adhesive failure is to the surface of the substrate 40 (shown in FIG. 6).

The invention has been described with respect to bonding getters directly to the surface of a substrate. Alternatively, the getters may be packaged in low-cost porous materials, such as Gore-Tex®, available from W.L. Gore & Associates, Inc., and stainless steel mesh. The low-cost porous materials can then be bonded to the surface of the substrate as described above.

The invention provides advantages in that getters can be secured to the surface of a substrate inexpensively using an adhesive. Getters bonded in this manner take up less space than the getters secured to a surface by a porous metal box. This means that bonded getters allow a higher getter density per surface and a corresponding increase in the amount of moisture that can be absorbed. The bond getter has been shown to be durable even after exposure to moisture. The bonded getter is not limited to removing moisture but can be used to purify air or liquids and to facilitate chemical reactions.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for attaching a getter to a surface, comprising:
applying an adhesive to the surface; and
applying the getter to the adhesive layer so as to bond the getter to the surface.

2. The method of claim 1, further comprising activating the bonded getter by heating.

3. The method of claim 1, wherein the adhesive comprises one selected from a group consisting of epoxies, polyimides, acrylates, silicone rubbers, thermosets, and thermoplastic materials.

4. The method of claim 1, wherein the getter comprises one selected from a group consisting of ZSM-5 zeolite, Zirconium-Aluminum, Zirconium-Vanadium-Titanium-Iron, and Zirconium-Vanadium-Iron.

5. A sealed package, comprising:
a container;
a lid sealed to the container; and
a getter bonded to an inner surface of the lid by an adhesive.

6. The sealed package of claim 5, wherein the adhesive comprises one selected from a group consisting of epoxies, polyimides, acrylates, silicone rubbers, thermosets, and thermoplastic materials.

7. The sealed package of claim 5, wherein the getter comprises one selected from a group consisting of ZSM-5 zeolite, Zirconium-Aluminum, Zirconium-Vanadium-Titanium-Iron, and Zirconium-Vanadium-Iron.

8. The sealed package of claim 5, wherein a fiber Bragg grating is mounted inside the container.

9. The sealed package of claim 8, wherein a negative expansion substrate is attached to the fiber Bragg grating.

10. The sealed package of claim 8, wherein the container is made of a material having low thermal expansion.

11. A sealed package, comprising:
a container;
a lid sealed to the container; and
a getter bonded to an inner surface of the lid by an adhesive, the getter being selected from a group consisting of ZSM-5 zeolite, Zirconium-Aluminum, Zirconium-Vanadium-Titanium-Iron, and Zirconium-Vanadium-Iron, and the adhesive being selected from a group consisting of epoxies, polyimides, acrylates, silicone rubbers, thermosets, and thermoplastic materials.
